(19) United States
(12) Patent Application Publication
(10) Pub. No.: US 2006/0038313 A1
(43) Pub. Date: Feb. 23, 2006

(54) Resin pin tip of pin chain and manufacturing method thereof

(76) Inventors: Shuji Sakaguchi, Ishikawa (JP); Yoshio Yasui, Ishikawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/205,162

(22) Filed: Aug. 17, 2005

(30) Foreign Application Priority Data
Aug. 18, 2004 (JP) 2004-238384

(51) Int. Cl. B29C 45/20

(52) U.S. Cl. 264/161; 425/568

(57) ABSTRACT

To provide a resin pin tip of a pin chain to be attached to distal end of a pin projecting from the pin chain to hold and convey a bottomed cylindrical body such as a can without causing scratches on its inner surface, a concave is formed on distal end surface of the pin tip, a gate port through which resin is injected is provided within the concave, and outer circumferential surface and the distal end surface of the pin tip are formed as smooth and glossy surfaces.

### BACKGROUND OF THE INVENTION

1. Field of the Invention

The present invention relates to a resin pin tip of a pin chain conveyer to hold and convey a bottomed cylindrical body such as a can, and to a method of manufacturing the pin tip.

2. Related Art

Recently, a considerable number of aluminum cans are used as containers of beverage such as beer and juice. Many of these cans are manufactured in plants, where beverage is packed into the inside of each can. During manufacture of such cans, it is required a number of processes such as printing on the outer circumferential surfaces of the cans, drying the cans, and coating on the inner surfaces of the cans, and the cans are conveyed through these processes using a pin chain conveyer. FIG. 7 illustrates aluminum cans held and conveyed by pin tips of a pin chain conveyer. Certainly, the same method is applicable to conveyance of steel cans.

The conveying speed of the aluminum cans (c) held and conveyed by the pin tips (b) of the pin chain conveyer (a) is considerably high, approximately 200 m/min. Therefore, the aluminum cans (c) held by the pin tips (b) are not stationary but tend to swing, thereby scratching the inner surfaces of the cans. These flaws thus produced make the coatings on the inner surfaces of the aluminum cans insufficient. As a result, corrosion occurs thereon, and the product quality of the beverage contained in the aluminum cans (c) is deteriorated.

A pin chain conveyer disclosed in JP-A-7-149417 is capable of preventing deformation of the opening edge of a can. More specifically, the pin chain conveyer includes a rotating chain, pins projecting from the chain, and pin tips having cylindrical outer surfaces to be attached to the ends of the pins. Each of the pin tips is covered by a bottomed cylindrical body in an upside-down position. The length of the pin tip is larger than the height of the bottomed cylindrical body. The end of the pin tip facing to the chain has a tapered shape that is tapered toward the end. Also, JP-A-7-149416 discloses a method of manufacturing a pin tip where an outer cylinder is formed on the outer circumferential surface of a cylindrical core by molding.

According to this pin tip, however, an injection gate port must be provided on the outer circumferental surface of the pin tip during molding for the structural reason, and therefore gate treatment and foil-burr treatment are required after molding. As a result, even though deformation of the opening edge of the bottomed cylindrical body held by the pin tip during conveyance is avoided, scratches to be produced on the inner circumferential surface of the cylindrical body cannot be prevented. That is, problems similar to those of the conventional typical pin tip (b) shown in FIGS. 8A and 8B arise from the above pin tip. The pin tip (b) is molded by injecting resin into a cavity of a metal mold, and the gate port is provided on the outer circumferential surface (d) at the distal end of the pin tip (b). Since the gate extending from the gate port remains on the outer circumferential surface (d), treatments for removing the gate and smoothing the outer circumferential surface (d) are needed.

FIGS. 8A and 8B illustrate the pin tip (b) from which the gate is removed. Since it is impossible to cut and remove only the gate extending from the outer circumferental surface (d), the outer circumferental surface (d) is simultaneously cut during the gate removal. As a result, a slight difference in level is produced on the outer circumferential surface (d), and the step may scratch the inner surface of the aluminum can (c). Thus, the pin tip (d) is roughly ground and finish ground after the gate removal so as to eliminate burrs on the outer circumferental surface (d), but it is difficult to produce the smooth outer circumferential surface (d) having no slight difference in level.

### SUMMARY OF THE INVENTION

Accordingly, for solving the above problems arising from the conventional pin tip, it is an object of the invention to provide a pin tip capable of conveying cans at high speed without scratching the inner surface of the cans, and a method of manufacturing the pin tip.

A pin tip of a pin chain conveyer according to the invention is a resin pin tip of a pin chain to be attached to the distal end of a pin projecting from the pin chain to hold and convey a bottomed cylindrical body such as a can. A concave is formed on the distal end surface of the pin tip. A gate port through which resin is injected is provided within the concave. The outer circumferential surface and the distal end surface of the pin tip are formed as smooth and glossy surfaces.

The resin pin tip of a pin chain is manufactured by: forming a cavity of a metal mold such that a concave can be provided on the distal end surface of the pin tip; forming a gate port through which resin is injected into the cavity within the concave; injecting resin through the gate port provided within the concave; and removing the gate after molding. The gate port may be provided on the bottom of the concave or on the inner side of the concave.

Since the pin tip according to the invention has the gate port through which resin is injected within the concave provided on the distal end of the pin tip, the gate port does not protrude from the distal end of the pin tip after the gate is removed from the molded pin tip. Thus, even if the gate mark is left within the concave, it may not exist on the outer circumferental surface and the distal end surface of the pin tip. As a result, only cutting the gate for the gate removal is required, yet the outer circumferental surface as a smooth and glossy surface can be obtained. Therefore, no scratches are produced on the inner surface of the can even when the can is conveyed at high speed by the conveyer chain having the pin to which the pin tip is attached. Moreover, no after-treatment such as finish grinding is required. Since the number of processes is smaller than that in the conventional pin tip manufacturing method, the manufacturing cost can be reduced.

### BRIEF DESCRIPTION OF THE DRAWING

FIGS. 1A and 1B are a vertical cross-sectional view and a plan view, respectively, illustrating a resin pin tip of a pin chain after molding prior to removal of a gate in a first embodiment according to the invention;

FIGS. 2A, 2B and 2C are a front view, a vertical cross-sectional view and a plan view, respectively, illustrating the pin tip from which a part of the gate is removed;

FIGS. 3A and 3B are vertical cross-sectional views showing examples of the distal end of the pin tip from which the gate is completely removed;

FIGS. 4A, 4B and 4C are a front view, a vertical cross-sectional view and a plan view, respectively, illustrating a pin tip in a second embodiment according to the invention;

FIG. 5 is a plan view illustrating the pin tip during use in the first embodiment;

FIG. 6 is a plan view illustrating the pin tip during use in the second embodiment;

FIG. 7 is a plan view schematically illustrating a pin chain conveyer; and

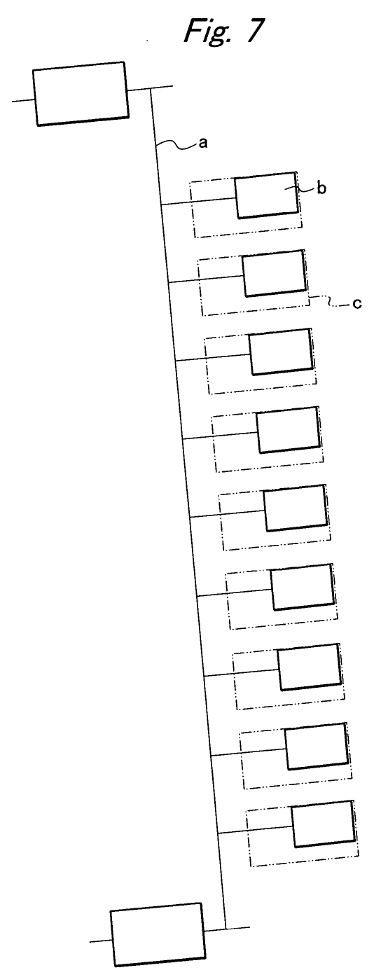

FIGS. 8A and 8B are a vertical cross-sectional view and a plan view, respectively, illustrating a conventional pin tip.

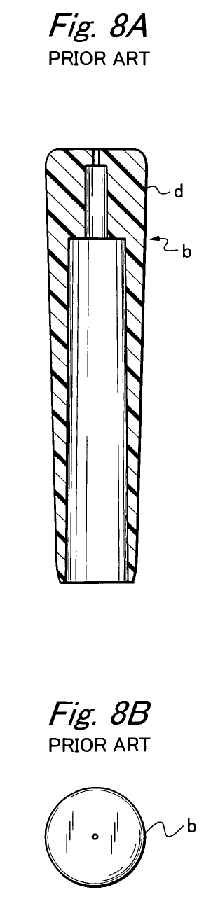

### DETAILED DESCRIPTION OF PREFERRED EMBODIMENT

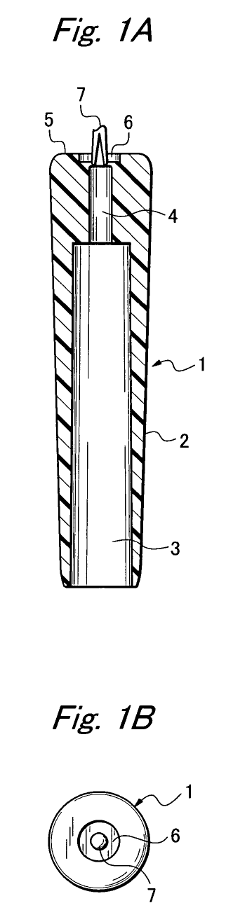

FIGS. 1A and 1B show a pin tip 1 in a first embodiment according to the invention. The pin tip 1 is a resin component formed by injection molding. The type of the resin used is not specifically limited. The resin is injected through a gate port into a cavity formed within a metal mold, and then the metal mold is opened to take out the resin after the resin is hardened. As illustrated in these figures, the pin tip 1 has a substantially cylindrical shape, and its outside diameter is slightly increased toward its distal end. Thus, an outer circumferential surface 2 has a slightly tapered shape.

The inside diameter of a center bore 3 is slightly decreased toward its distal end and is increased toward its base. A small engagement hole 4 with which a pin engages extends from the upper end or ceiling of the bore 3 to a distal end surface 5. A concave 6 is provided on the distal end surface 5 around the engagement hole 4. A gate 7 prior to removal extends from the bottom of the concave 6. Resin is injected through the gate 7 into the cavity of the metal mold to form the pin tip 1 shown in FIGS. 1A and 1B.

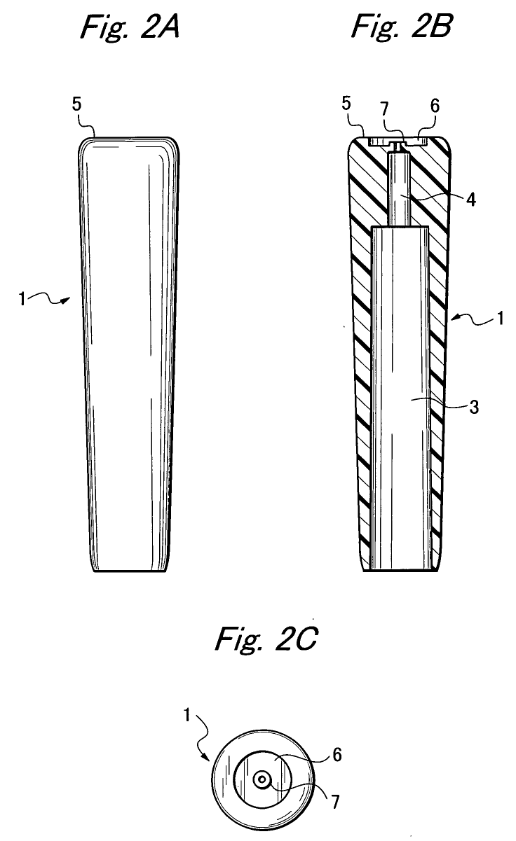

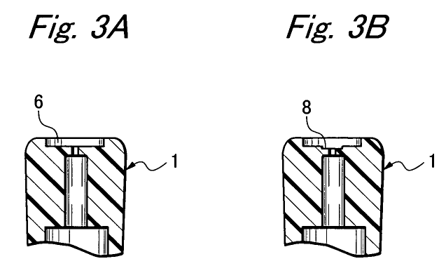

Since the gate 7 is still connected with the pin tip 1 when the metal mold is opened after molding, the gate 7 has to be removed. FIGS. 2A, 2B and 2C show the pin tip 1 from which the gate 7 is removed, but a part of the gate 7 still remains thereon. FIGS. 3A and 3B illustrate the pin tip 1 from which the gate 7 is completely removed. FIG. 3A shows an example in which the gate 7 is removed until the bottom of the concave 6, while FIG. 3B shows another example in which the gate 7 is removed forming a shallow concave 8 which is more deeply cut than the bottom of the concave 6. According to the examples shown in these figures, the gate 7 is completely removed from the distal end of the pin tip 1.

After the gate 7 is removed from the distal end of the pin tip 1, a part of the gate 7 may remain thereon as illustrated in FIGS. 2A through 2C. However, the remaining part of the gate 7 does not cause any obstacle since it does not protrude from the distal end surface 5. The outer circumferential surface 2 of the pin tip 1 is a formed surface, which is smooth and specular. Similarly, the distal end surface 5 is formed as a specular surface.

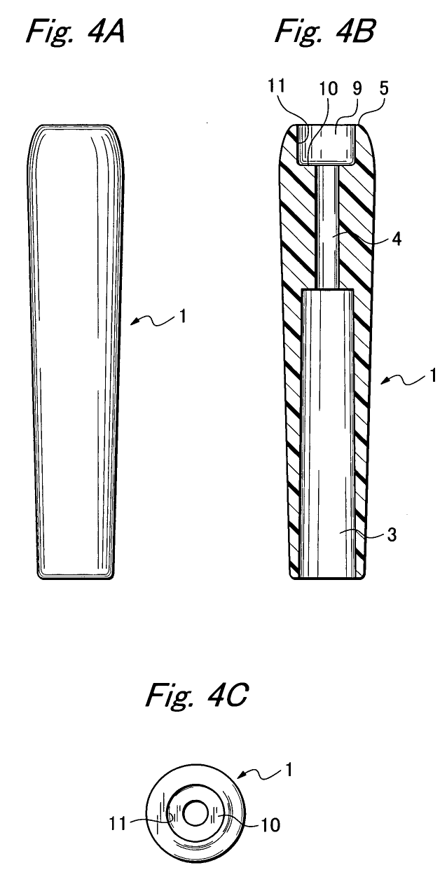

FIGS. 4A through 4C illustrate a pin tip 1 in a second embodiment. Similarly to the first embodiment, the pin tip 1 has a cylindrical shape. The outside diameter of the pin tip 1 is slightly increased toward the distal end, and the outer circumferental surface 2 is slightly tapered. The inside diameter of the center bore 3 is slightly decreased toward the distal end and is increased toward the base. A deep concave 9 is provided on the distal end 5. The small engagement hole 4 with which a pin engages extends from the upper end or ceiling of the bore 3 to the concave 9.

A gate port used for forming the pin tip 1 by injection molding is provided on a hole bottom 10 or on a hole inner side 11 within the concave 9. Thus, the gate mark does not exist on the outer circumferental surface 2 and the distal end surface 5 after removal of the gate remained after molding. Accordingly, the pin tip 1 does not scratch the inner surface of the can held and conveyed by the pin tip 1.

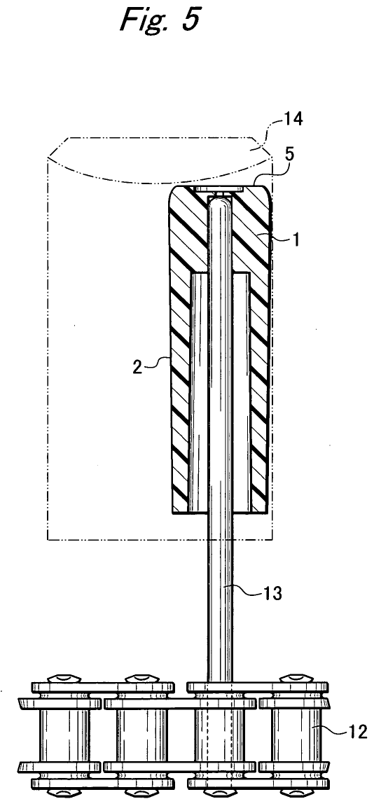

FIG. 5 illustrates the pin tip 1 during use in the first embodiment. The pin tip 1 is attached to a pin 13 of a pin chain 12, and a can 14 is held by the pin tip 1. The pin 13 extends from the pin chain 12 and engages with the engagement hole 4, thereby connecting with the pin tip 1. Since the outer circumferential surface 2 and the distal end surface 5 are smooth and specular, the can 14 can be conveyed with no scratches left on its inner surface.

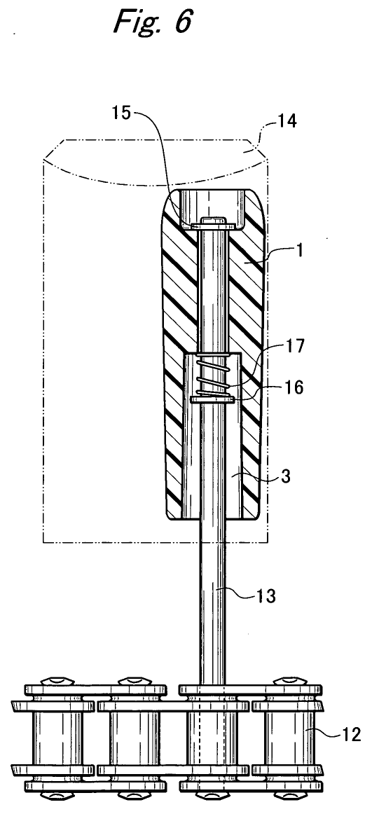

FIG. 6 illustrates the pin tip 1 during use in the second embodiment. The pin tip 1 is attached to the pin 13 of the pin chain 12, and the can 14 is held by the pin tip 1. The pin 13 extends from the pin chain 12 and engages with the engagement hole 4. The pin 13 is sandwiched between an upper washer 15 attached to the distal end of the pin 13 and a lower washer 16 attached to the pin 13 on the bore 3 side. A coil spring 17 is interposed between the lower washer 16 and the upper end or ceiling of the bore 3 such that shock in the direction toward the pin 13 can be absorbed. Since the outer circumferential surface 2 and the distal end surface 5 are smooth and specular similarly to the case of the first embodiment, the can 14 can be conveyed with no scratches left on its inner surface.

What is claimed is:

1. A resin pin tip of a pin chain to be attached to distal end of a pin projecting from the pin chain to hold and convey a bottomed cylindrical body such as a can, wherein:
a concave is formed on distal end surface of the pin tip;
a gate port through which resin is injected is provided within the concave; and
outer circumferential surface and the distal end surface of the pin tip are formed as smooth and glossy surfaces.

2. A resin pin tip of a pin chain according to claim 1, wherein the gate port is provided on the bottom of the concave.

3. A resin pin tip of a pin chain according to claim 1, wherein the gate port is provided on the inner side of the concave.

4. A method of manufacturing a resin pin tip of a pin chain to be attached to distal end of a pin projecting from the pin chain to hold and convey a bottomed cylindrical body such as a can, comprising the steps of:
forming a cavity of a metal mold such that a concave can be provided on distal end surface of the pin tip;
forming a gate port through which resin is injected into the cavity within the concave;
injecting resin through the gate port; and
removing the gate after molding.
